(19) United States
(12) Patent Application Publication
(10) Pub. No.: US 2008/0109293 A1
(43) Pub. Date: May 8, 2008

(54) System and Method for Communication Market Information

(75) Inventor: Simon Leslie Huckle, Walton-on-Thames (GB)

Correspondence Address: PHILIPS ELECTRONICS NORTH AMERICA CORPORATION;INTELLECTUAL PROPERTY & STANDARDS, 370 W. TRIMBLE ROAD MS 91/MG, SAN JOSE, CA, 95131, US

(73) Assignee: Koninklijke Philips Electronics

(21) Appl. No.: 10/541,900

(22) PCT Filed: Jan. 12, 2004
(86) PCT No.: PCT/IB04/50005

§ 371 Date: Jul. 7, 2005

(30) Foreign Application Priority Data
Jan. 14, 2003 (EP) 03250216.3

(51) Int. Cl. G06Q 99/00; G06F 17/30

(52) U.S. Cl. 705/10

(57) ABSTRACT

The invention relates to a communication system for gathering, bundling and communicating market information and to a method of communicating such information.

The invention relates to a communication system for gathering, bundling and communicating market information and to a method of communicating such information.

Pieces of modern electronic equipment, such as a television sets or CD-players, usually contain many integrated circuits. Building such equipment and providing the required integrated circuits in time involves the coordinated activity of a great number of people. Usually, the equipment manufacturers obtain different integrated circuits in each piece of equipment from different integrated circuit manufacturers. Within the organizations of each integrated circuit manufacturer many different specialized groups of people are involved in marketing, design, processing, packaging, sale and delivery of these integrated circuits. Usually, each group is involved with handling one aspect of many integrated circuit types, and often each group is involved with a different cross-section of the total catalogue of integrated circuits that the integrated circuit manufacturer is capable of delivering at any time.

All these groups require information for planning their activities and taking optimal decisions, so as to be able to seize opportunities to maximize the value delivered by the integrated circuit manufacturer. Data from the sales force, specifying the number of integrated circuits of different types sold to different customers, together with projected sales of these types is used in the planning process for the production of integrated circuits that have been sold. But for optimal operation information about existing and planned sales of integrated circuits is insufficient: data is needed about the opportunities of selling other integrated circuits and the conditions that have to be met to seize these opportunities. Obtaining and distributing this type information throughout the organization poses considerable problems.

Conventionally, strategic marketing departments have fulfilled these tasks. Such marketing departments develop a vision of trends and translate this vision into predictions of the parameters that are relevant to specialized groups within the organization of a manufacturer. This requires a significant effort, due to the many divergent groups of specialists that require different kinds of information.

The sales force is sometimes also questioned about their perception of future trends of customers. Potentially, the sales force is an important source of relevant market information, because it is in direct contact with customers that build the equipment in which the integrated circuits are used. However, in view of the many divergent groups of specialists that require different kinds of information, it has hardly been feasible for every group to ask for this kind of service from the sales force in addition to normal activities. What is needed is a way to structure information gathering from the sales force to point that information gathering about opportunities and distribution of this information can be automated.

Amongst others, it is an object of the invention to provide for a communication system that collects information from the sales force in a structured way, so that relevant information for other users becomes available, and controls the combination of the information so that useful information can be output to the other users.

The invention provides for a communication system according to claim 1. The, system is oriented towards different types of equipment and uses a respective computer readable list of functions for each respective type of equipment, indicating functions to be performed in the equipment. The communication system uses the list of functions to structure the input interface towards members of the sales force, providing fields in which sales data of components that implement the functions in a specific customer product. The sales data includes for example per function the type number of a device that performs the function in the customer product, if known, the reason why another available device was not used etc. Sales engineers collect this type of data when they have contacts with customers for selling components. In addition information about the projected manufacturing volume of the customer product is entered. This information may be implicit in the volume of orders of a component that is known to be intended to perform a function in the customer product, but may also be entered explicitly. If possible, this number is entered even if the sales engineer does not receive an order for components that implement any of the functions. The data from the sales force is stored and data about the same function for different customer products is gathered for output. Because the data is gathered per function an automatic interface to other users is possible, normally without having to contact the sales engineers that collect the data again. By using a form that has been prepared for the type of product in which the customer will use the components that are sold, the communication system uses the sales process to gather additional information about opportunities to sell other components.

In an embodiment the interface contains per function a field for entering data why a component has not been sold. Thus systematic entry of data becomes possible even about components that are not sold. By entering reasons per function why a customer does not buy a component for that function, systematic sales data is made available that can be automatically be gathered into relevant information about missed opportunities for other users.

These and other advantageous aspects of the communication system according to the invention will be described in more detail using the following figures

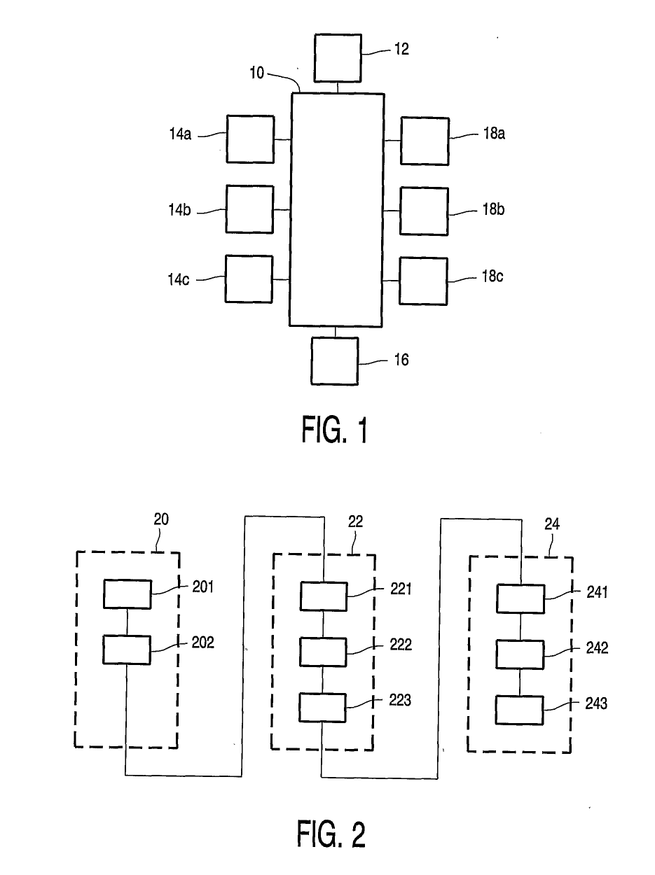

FIG. 1 shows an information communication system

FIG. 2 shows a flow chart of the operation of the communication system

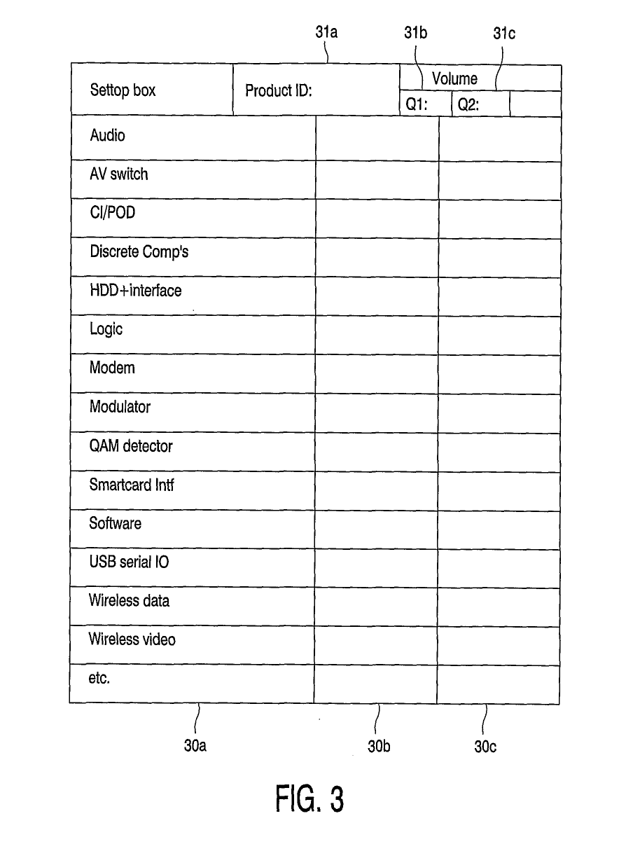

FIG. 3 shows an input interface layout

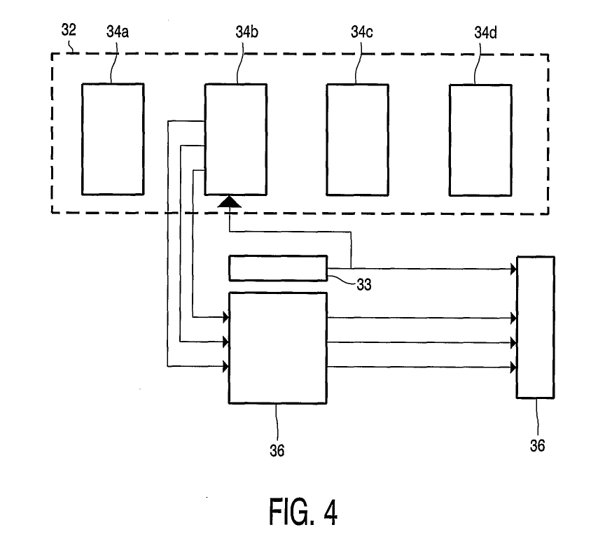

FIG. 4 shows data relations

FIG. 1 shows a communication system. The system contains a central computer 10 coupled to a programming input 12, input terminals 14a-c, a storage device 16 and output terminals 18a-c. Although the communication system is illustrated using a central computer 10 with direct connections to the terminals etc. it will be understood that the terminals etc. may be coupled indirectly to the central computer 10, for example via network connections. Instead of a single storage device, a system of different storage devices may be used and instead of a central computer distributed computers may be used.

In operation the communication system is used to gather information from sales engineers at input terminals 14a-c, to store and arrange the information in storage device 16 and to combine and select data from the stored information, and to display the combined data to planners at output terminals 18a-c. Programming input 12 is used to enter information about the structure of equipment for which the sales engineers sell components.

FIG. 2 shows a flow chart of the operation of the communication system. The flow chart is structured into a number of processes 20, 22, 24 for defining structure information, entering sales related information and retrieving information about opportunities respectively. These processes are shown sequentially, because information from each process is needed by a subsequent process, but it must be understood that the communication system is arranged to allow the processes to be executed repeatedly independent of one another to update the information produced by each process, possibly asynchronous from the other processes.

In a first step 201 of the process 20 for defining structure information a first step 21 the communication system receives structure information from programming input 12 and stores the structure information in storage device 16. In a second step 202 the communication system stores the structure information. The communication is arranged to store different items of structure information for each of a number of different types of equipment, for example for equipment such as a television set, a set-top box, a CD-player etc. For each piece of equipment the structure information identifies a number of functions that has to be implemented in the equipment. For different types of equipment the functions or the combination of functions is different. Table I shows an example of the functions identified for a set-top box, and information that can be entered.

TABLE I
functions in STB product

1394 interface
Audio
AV switch
CI/POD
Discrete components
HDD + interface
Logic
Modem
Modulator
QAM detector
Smartcard interface
Software
USB serial IO
Wireless data
Wireless video
Flash memory
SDRAM memory

In addition storage device 12 may contain data (component ID, function) representing the function implemented for each component type number that the sales organization can deliver or plans to be able to deliver.

Sales engineers are usually specialized: each is assigned to one customer, or to a limited number of customers, and usually also to selling components for a limited range of equipment. When the sales engineer enters data in the communication system the sales engineer has to indicate the type of equipment of the customer for which the sales engineer is about to enter data, e.g. whether the equipment is a set top box or a DVD player etc. In a first step 221 of the process 22 for entering sales related information the communication system prompts a sales engineer to provide some identifier that identifies the equipment for which data is to be entered (e.g. in the form of a product number, such as ASP2000, or ASP 2100 etc). The communication system also prompts a sales engineer to the type of equipment via an input terminal 14a-c.

In response, in a second step 221 of the process 22 for entering sales related information the communication system retrieves the structure information for the indicated type of equipment from storage device 16 and uses this information to generate an input form at the input terminal 14a-c. The input form shows the sales engineer functions for components that are expected to be present in the equipment. FIG. 3 shows an example of a screen interface generated at input terminal 14a-c. The screen contains three columns 30a,b,c of fields. The first column 30a contains identifications of functions in the selected type of product, read storage device 12 from the data represented in table I. The second column 30b contains fields for entering data about sales made of devices implementing the functions. The third column 30c contains fields for entering reasons why available devices for a function were not sold. Separate fields 31a,b,c are shown for entering a product ID for identifying the customer product (e.g. “ASP2000”) and for projected manufacturing quantities of the product as a function of time (for example for respective quarters of a year).

It will be appreciated that FIG. 3 is merely shown by way of example. In practice different layouts may be used, or different fields for entering data may be presented successively. Also, the word “field” should be understood in general terms: a field such as an keyboard editable window on a computer screen may be used, for example or in an audio input terminal the field might correspond to a time window in which the system will copy information for the field from a microphone input.

The sales engineer enters information about the components that fulfil these functions in the relevant equipment of the customer in the fields. The sales engineer may enter type number information for those components that the sales engineer has sold to the customer for use in manufacturing the equipment. Preferably, the sales engineer also enters information indicating why available components for fulfilling other functions in the equipment have not been sold. For this purpose, the communication system may retrieve data from storage device 12 to indicate the available component type number(s) for each function in the interface of FIG. 3, jointly with a field for entering the reason why the component was not used, to be entered by the sales engineer.

In addition to the fields shown, additional data may be added for each field, such as

the number of times the function occurs in the equipment,

the (average) selling price of paid for parts that perform the function

an identification of the supplier that currently supplies the parts

a likelihood that a specific part will be used to fulfil the function

action needed to be able to sell the specific part for the equipment

the part number used by the equipment maker to indicate the component that performs the function

The sales engineer also enters information about the number of pieces of equipment to be made by the customer, preferably as a function of time of manufacture, either directly or indirectly through the number of components sold to fulfil relevant functions as a function of projected delivery time.

Table II illustrates a table in which relations between equipment type and customer equipment type may be stored.

TABLE II
product ID data

| Equipment type | Product ID |
|---|---|
| STB | ASP2000 |

### Table III illustrates a table for storing information about the (projected) number of pieces of the equipment that is to be manufactured as a function of time.

TABLE III
(projected) number of pieces

| Product ID | Period | quantity |
|---|---|---|
| ASP2000 | P1 | X1 |
| ASP2000 | P2 | X2 |
| ASP2000 | P3 | X2 |
| ASP2000 | P4 | X2 |

Thus, jointly with table I indirectly the sales engineer also generates information about the market size for selling components to fulfil functions for which the sales engineer has not sold components. In a third step 223 of the process 22 for entering sales related information, the communication system stores the information entered by the sales engineer at the input terminal 14a-c in storage device 16.

Table IV illustrates a table for storing sales related information for the product ID, such as number of devices of a certain type No sold and/or reason for selling/not selling the device

TABLE IV
data about functions for a product ID

| Product ID | Function | Type No | Volume | Reason |
|---|---|---|---|---|
| ASP2000 | Volume | X1 | 100% | |
| ASP2000 | 1394 interface | X3 | | price 20% |
| | | | | too high |
| ASP2000 | Audio | X4 | | power |
| | | | | dissipation |
| | | | | 10% |
| | | | | too high |
| ASP2000 | AV switch | X2 | 100% | |
| ASP2000 | CI/POD | | | |
| ASP2000 | Discrete components | | 50% | |
| ASP2000 | HDD + interface | | | |
| ASP2000 | Logic | | 10% | |
| ASP2000 | Modem | | | |
| ASP2000 | Modulator | | | |
| ASP2000 | QAM detector | | | |
| ASP2000 | Smartcard interface | | | |
| ASP2000 | Software | | | |
| ASP2000 | USB serial IO | | | |
| ASP2000 | Wireless data | | | |
| ASP2000 | Wireless video | | | |
| ASP2000 | Flash memory | | | |
| ASP2000 | SDRAM memory | | | |

FIG. 4 illustrates a structure of the data stored in storage device 12. The data structure contains function list data 32, which is shown organized into lists 34a-d for different types of equipment. Equipment field input data 33 from an input terminal 14a-c selects one of the lists 34a-c, which controls the content of the input interface data 36. This input interface data 36 together with the equipment field input data and data entered into the fields 30b,c for various functions is used to generate storage data 38, which may in the form of records of the type

product ID,

function,

component ID performing function,

quantity used,

reason

During the process 24 for retrieving information about opportunities, in a first step 241 users at output terminals 18a-c start computer programs in central computer 10 to gather information about market opportunities. For example, the user specifies the functions that can be fulfilled by a component in various types of equipment. In response the communication system executes a second step 242 to gather stored information from storage device 16, for example by identifying all types of equipment that include the function, identifying all product IDs that are of the identified type and summing the numbers of pieces of equipment for those product ID's that are expected to be manufactured in a certain period, according to information stored into storage device 16. In a third step 243 the information that has been gathered is displayed to the user at the output terminal 18a-c. Thus, information entered by many different persons is combined and communicated to a single output.

Many kinds of information may be gathered. For example, marketing managers can compute the available marker for devices for various functions, and identify how much of that market (if any) is served by a company. For this purpose the number of devices sold by a manufacturer for implementing the function in various equipment may be summed. As another example, market opportunities for functions for which no products are available can be identified.

In another example, design managers that are responsible for designing circuit library modules for use in various integrated circuit types, may specify a class of functions of integrated circuits that use a certain possible circuit module that could be added to the library, in order to find out whether the design of such a module is profitable and when the design of such a module has to be available. In response, computer 10 gathers the expected manufacturing numbers of devices for performing the functions, sums these numbers and outputs them at a terminal 18a-c.

In case of existing devices, a design manager responsible for a device with a certain function may gather data on the reasons why the device did not capture the available market. In this case an identification of the device is entered at a terminal. In response the communication system executes a second step 242 to gather stored information from storage device 16, for example by identifying all types of equipment that include the function performed by the identified device, identifying all product IDs that are of the identified type and collecting the reasons why the identified device was not sold. In a third step 243 the information that has been gathered is displayed to the user at the output terminal 1 8a-c. Preferably, computer 10 also sums the expected manufacturing numbers of pieces of the equipment that include the function of the device, but did not use the device for each reason. This provides information about the available increase in sales if certain improvements to the device would be made.

The information in storage device 12 may be supplemented with more general market data, such as data about the total expected market for each of a plurality of types of equipment, in the form of records containing the fields (eq. type, period, volume). This information may be used, in combination with the lists of functions for each type of equipment, to compute the total market for a component for implementing a specific function. This computation involves summing the volumes of all equipment types that include the specific function (if necessary multiplying by a factor if the function is performed by more than one component in parallel in the equipment). A comparison between the more general market data and the predictions from data entered by sales engineers may be used to track down errors or incompleteness of coverage.

When a new type of equipment or a new function is encountered, preferably, a list defining the new type of equipment is added, or new functions are added to lists of existing equipment. Thus, the interface for use by the sales engineer is defined in terms that make it possible to enter data about the new type of equipment so that this data can be combined later with data for other equipment types for display to different users.

Although the invention has been described in terms of a specific embodiment it will be appreciated that many alternative embodiments are possible. For example, instead of a single general purpose computer 10 a network of computers may be used, such as a network of PC's, in which one or more servers store the information and different PC's process data from the server and serve as input or output device. Similarly, instead of the basic interfaces shown, more graphically appealing interfaces may be used, with a different layout, or interfaces that shown certain fields only under certain circumstances, but always fields that may be used are determined from the list of functions for the specific type of apparatus that has been selected.

1. A communication system for communicating market information derived from sales engineers, the system comprising
a storage device for storing descriptions of a plurality of different types of equipment, each description containing a list of functions fulfilled by components of the equipment
input means, arranged
to input an equipment type identification of a customer product, and
to generate an input interface for inputting sales data of the components for use in the customer product under control of the stored list of functions for the identified equipment type, providing input fields for receiving sales data of components per function in the customer product and information specifying a projected manufacturing volume of the product, and
to store the sales data entered in the fields and said number in the storage device;
computing means for gathering the sales data for a selected one or more of the functions entered for different products from the storage device and computing market volume data for the selected one or more functions from the gathered sales data;
output means arranged to output information about the market volume.

2. A communication system for communicating market information according to claim 1, the system being arranged to compute the manufacturing volume of the customer product from sales volume for at least one of the functions.

3. A communication system for communicating market information according to claim 1, having an input structure for entering the information specifying the manufacturing volume representing the projected manufacturing volume dependent on time.

4. A communication system for communicating market information according to claim 1, the input interface comprising per function a field for entering information about a reason why a specified component was not sold for implementing the function, said computing comprising gathering the information about said reason for the specified component for different products from the storage device and to output the gathered information about said reason on the display device.

5. A method of communicating market information derived from sales engineers, the method comprising
storing computer readable descriptions of a plurality of different types of equipment, each description containing a list of functions fulfilled by components of the equipment
receiving an equipment type identification of a customer product and information specifying a projected manufacturing volume of the customer product;
generating a computer input interface for inputting sales data of the components for use in the customer product under control of the stored list of functions for the identified equipment type, providing input fields for receiving sales data of components per function in the customer product;
entering the sales data in the fields;
storing the sales data entered in the fields and said number in a storage device;
gathering the sales data for a selected one or more of the functions entered for different products from the storage device;
computing market volume data for the selected one or more functions from the gathered sales data in the storage device;
output information about the market volume on a display device.

6. A method of communicating market information according to claim 5, the method comprising computing the manufacturing volume of the customer product from sales volume for at least one of the functions.

7. A method of communicating market information according to claim 5, wherein the information specifying the manufacturing volume is entered representing the projected manufacturing volume dependent on time.

8. A method of communicating market information according to claim 5, the method comprising providing, in the interface, per function a field for entering information about a reason why a specified component was not sold for implementing the function, the method comprising gathering the information about said reason for the specified component for different products from the storage device and to output the gathered information about said reason on the display device.

9. A method of communicating market information derived from sales engineers, the method comprising
providing computer readable descriptions of a plurality of different types of equipment, each description containing a list of functions fulfilled by components of the equipment;
structuring electronic input of sales data of the components under control of the descriptions, so that the function to be fulfilled by components sold in a specified type of equipment are computer readable, together with information specifying a number of pieces of the specified piece of equipment;
displaying information about opportunities to sell components to fulfil functions in the specified equipment for which no sales data has been entered.
